(19) United States
(12) Patent Application Publication
(10) Pub. No.: US 2019/0186572 A1
(43) Pub. Date: Jun. 20, 2019

(54) INTEGRAL ROD AND SPRING FOR A DAMPER

(71) Applicant: Suspa GmbH, Altdort (DE)

(72) Inventors: Michael Bauer, Freihung (DE); Michael Weder, Nürnberg (DE); D. Stuart Atwater, Grand Rapids, MI (US); James Lee Vander Zanden, Grand Rapids, MI (US); Jonathan David Bruin, Grand Rapids, MI (US)

(21) Appl. No.: 16/309,201

(22) PCT Filed: Jun. 13, 2017
(86) PCT No.: PCT/US2017/037245

§ 371 Date: Dec. 12, 2018

Related U.S. Application Data
(60) Provisional application No. 62/351,345, filed on Jun. 17, 2016.

(51) Int. Cl. F16F 1/12; F16F 7/08

(52) U.S. Cl. CPC F16F 1/123; D06F 37/20; F16F 7/08

(57) ABSTRACT

A coil spring integrally includes opposed extending ends to define a control rod for a damper. Thus, the spring and control rod are integrated into a one-piece structure. A friction rod damper includes a coil spring having a longitudinal axis, with the spring including a body and first and second extending ends which define a control rod for the damper. The extending ends terminate in attachments, and a damper member extends through the spring and having a first end secured to the first extending end of the spring in spaced relationship to the associated attachment. The damper member includes a second end with a container surrounding the second end of the spring in spaced relationship to the associated attachment. The container includes a damping element engaging the control rod to allow the spring to expand and contract under the damping action of the damping element.

### BACKGROUND OF THE INVENTION

The present invention relates to an integral spring and control rod for use with a damper and a damper employing the same.

Mechanical dampers are employed in a variety of environments for damping excessive or unwanted motion. One example is a washing machine where unbalanced loads tend to cause excessive vibration. U.S. Pat. Nos. 7,445,098, 7,549,519, 5,230,229, and 5,080,204 and US Publication Nos. 2003/0183994 and 2016/0024705, the disclosures of which are incorporated herein by reference, are examples of different types of dampers and their usage in washing machines. Such dampers have a control rod with one end which is typically fixed to a frame, for example, of a washing machine. An opposite end of the control rod extends through the damper and can be attached to a movable element of the washing machine for which movement is desired to be dampened. The damper also includes a frictional damping element which interacts between the control rod and a movable part of the damper. The damping element frequently includes a polymeric pad and grease to provide the desired amount of damping action. The damper also typically includes a spring which extends between one end of the damper and a fixed end attached to the damper, such that, when movement occurs, the damper is spring returned to its at rest position under the influence of either a spring in compression or a spring in extension, depending upon the specific damper design and application. Typically, the spring is a separate component of the damper assembly and coaxially surrounds the control rod, as disclosed in the above-identified patents and publications.

### SUMMARY OF THE INVENTION

This invention integrates a coil spring with extensions on opposite ends of the spring to define a control rod for a damper. Thus, the spring and control rod are integrated into a one-piece structure. This eliminates the need for two separate components, namely, a spring and a separate control rod. By integrating the coil spring and control rod, a damper can be designed using fewer parts in a unique configuration. This invention further contemplates a friction rod damper comprising a coil spring having a longitudinal axis, with the spring including a body and first and second extending ends which extend longitudinally from the body of the spring and define a control rod for the damper. The extending ends terminate in attachments, and a damper member extends coaxially through the spring and has a first end secured to the first extending end of the spring in spaced relationship to an associated attachment. The damper member includes a second end with a container surrounding the second extending end of the spring in spaced relationship to an associated attachment. The container includes a damping element engaging the second extending end of the spring, wherein the damper member allows the spring to expand and contract with its integral control rod engaged by the damping element to provide damping.

These and other features, objects and advantages of the present invention will become apparent upon reading the following description thereof together with reference to the accompanying drawings.

### BRIEF DESCRIPTION OF THE DRAWINGS

FIG. 1 is a cutaway perspective view of a washing machine employing multiple dampers of the present invention;

FIG. 2 is a side elevational view of one of the dampers shown in FIG. 1;

FIG. 3 is a top plan view of the damper shown in FIG. 2;

FIG. 4 is an exploded perspective view of the damper shown in FIGS. 2 and 3;

FIG. 5 is a vertical cross-sectional view of the damper shown in FIG. 2;

FIG. 6 is a fragmentary perspective view of an alternative connection between the control rod and the fixing element of the damper of the present invention;

FIG. 7 is a fragmentary perspective view of an alternative design for the connection between the control rod and the fixing element;

FIG. 8 is an enlarged fragmentary perspective view of an alternative embodiment of the connection between the control rod and the fixing element;

FIG. 9 is a greatly enlarged top fragmentary plan view of the fixing element and control rod shown in FIG. 8;

FIG. 10 is a vertical cross-sectional view of the control rod and fixing element shown in FIG. 8;

FIG. 11 is a perspective view of the damper of the present invention employing yet another alternative embodiment of the connection of the control rod and fixing element;

FIG. 12 is a vertical cross-sectional view of the damper shown in FIG. 11;

FIG. 13 is an enlarged fragmentary top plan view of the control rod and fixing element shown in FIGS. 11 and 12;

FIG. 14 is a perspective view of an alternative embodiment of one of the dampers shown in FIG. 1;

FIG. 15 is an exploded perspective view of the damper shown in FIG. 14; and

FIG. 16 is an exploded perspective view of an alternative embodiment of the damper shown in FIGS. 14 and 15.

### DETAILED DESCRIPTION OF THE PREFERRED EMBODIMENT

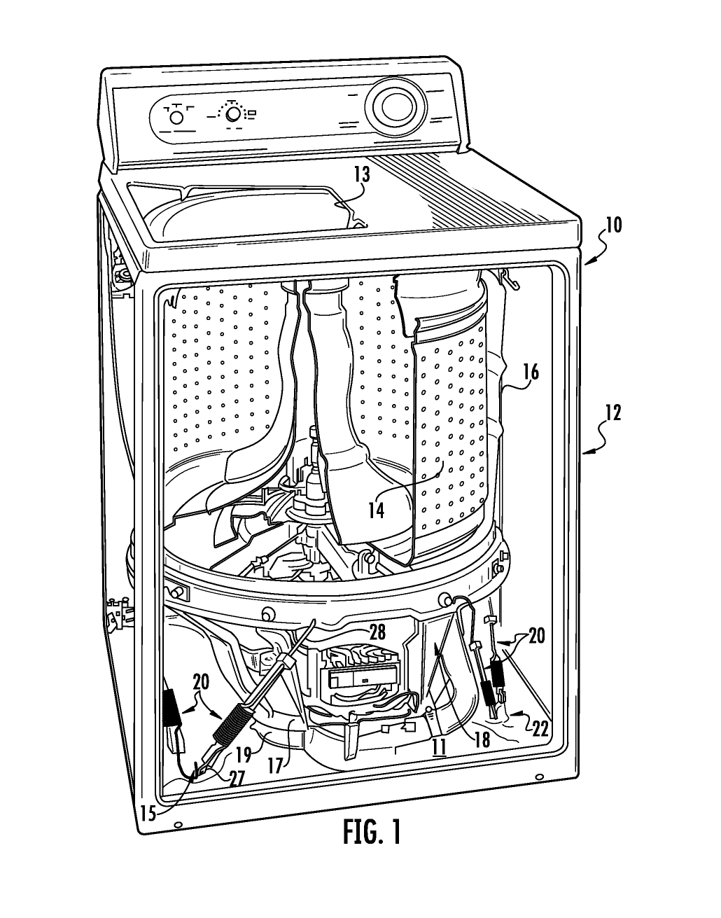

Referring initially to FIG. 1, there is shown a top-loading washing machine 10, which includes a cabinet 12 and a drum 14 for receiving clothes and other items to be laundered through a hinged cover (removed) over opening 13 in the top of cabinet 12. Drum 14 rotates and agitates the clothes during wash and spin dry cycles and is subject to vibrations during normal operation of the machine and particularly when there are unbalanced loads. Drum 14 is enclosed by an outer drum 16 supported by a frame 18 including legs and a lower ring 17 mounted on a bearing 19. This allows both drum 14 and surrounding rotationally fixed drum 16 to move during washing cycles. In order to stabilize the drums, a plurality of dampers 20 embodying the present invention extend between outer drum 16 and anchors 15 in the floor 11 of the cabinet 12. In FIG. 1, four such dampers 20 are seen, it being understood that a greater or fewer number can be employed depending on the washer design. In the washer design of FIG. 1, the dampers 20 act in an extension mode, however the damper design can be adapted for hanging a drum from the washer cabinet, as seen in U.S. Pat. No. 7,549,519, or in other configurations as well as in other embodiments and environments including, but not limited to, front-loading washers.

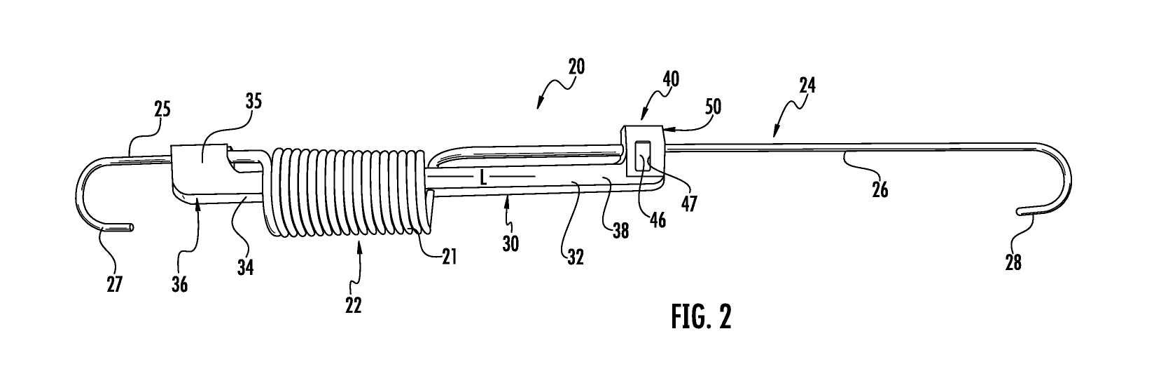

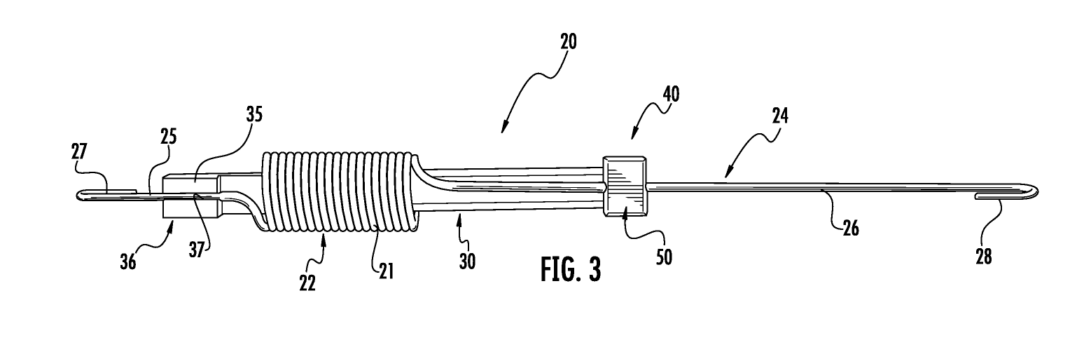

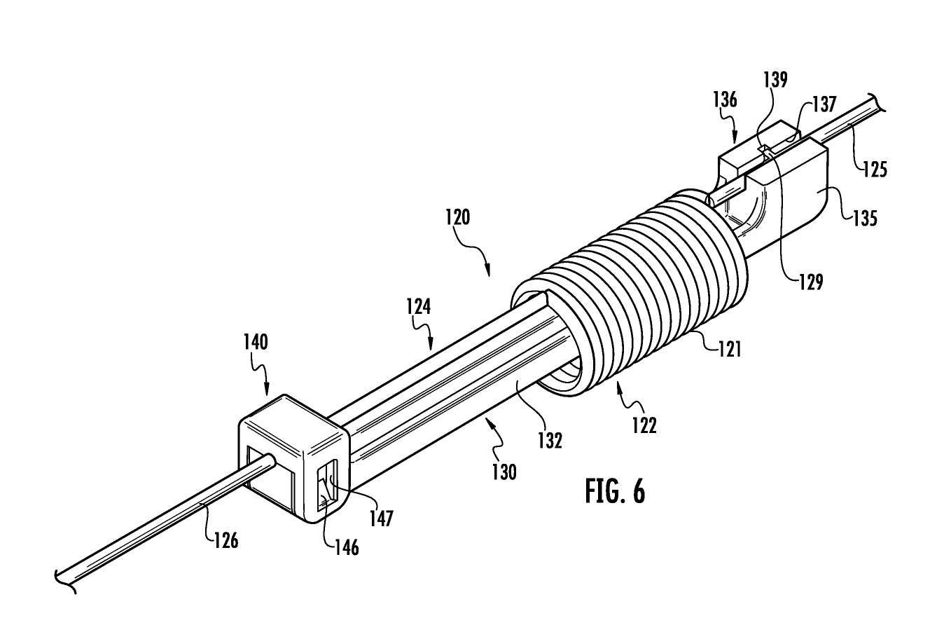

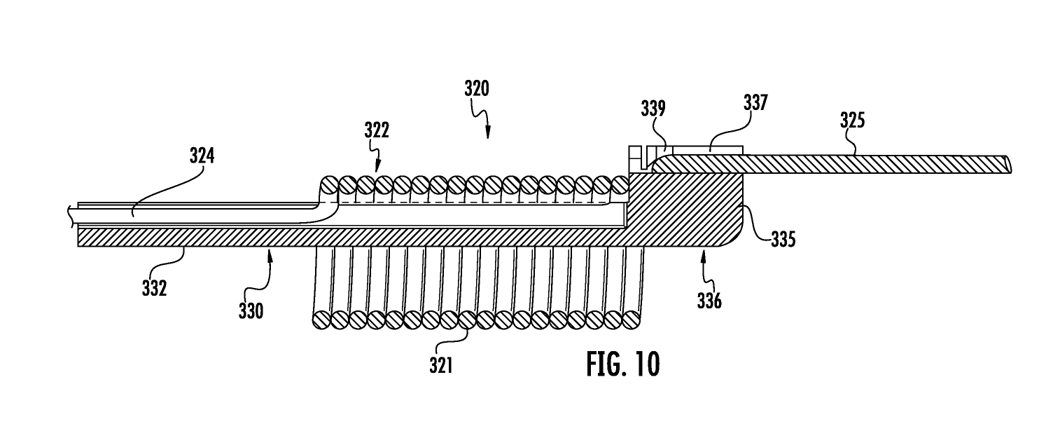

Each of the dampers 20, shown in FIG. 1, can be of the type shown in the detailed drawings of FIGS. 2-5 or their alternative embodiments in FIGS. 6-16. Referring now to FIGS. 2-5, there is shown a damper 20 which includes an integral coil spring 22 and control rod 24 extending from opposite ends of the spring body 21. The integral coil spring 22 is made of spring music wire, such as ASCMA228 spring material, which is commercially available from a variety of sources. The integral coil spring 22 has an outside diameter of about 2-4 mm and preferably 3 mm. The spring constant “k” for spring 22 can be from 2 to 4 N/mm and, in one embodiment, is 3.25 N/mm. The control rod 24 is defined by extending ends 25 and 26 of spring body 21 and are integral with the body 21 of coil spring 22 forming one piece. The control rod 24 extends longitudinally outwardly from the spring body 21 in spaced relationship to the central longitudinal axis L of the spring 22, as seen in FIG. 2. The control rod 24, therefore, is aligned with the longitudinal axis of the spring in offset relationship and extends generally longitudinally from the outer coils at opposite ends of the spring body 21.

Extending end 25 terminates in an attachment 27 in the form of a hook, while extending end 26, which is longer than extending end 25, also terminates in an attachment hook 28. Other attachments may be used depending upon the environment of the damper. Hooks 27, 28, as seen in FIG. 1, are attached to the anchor 15 on the floor 11 of cabinet 12 and the lower edge of outer drum 16 to stabilize both drums during a washing cycle.

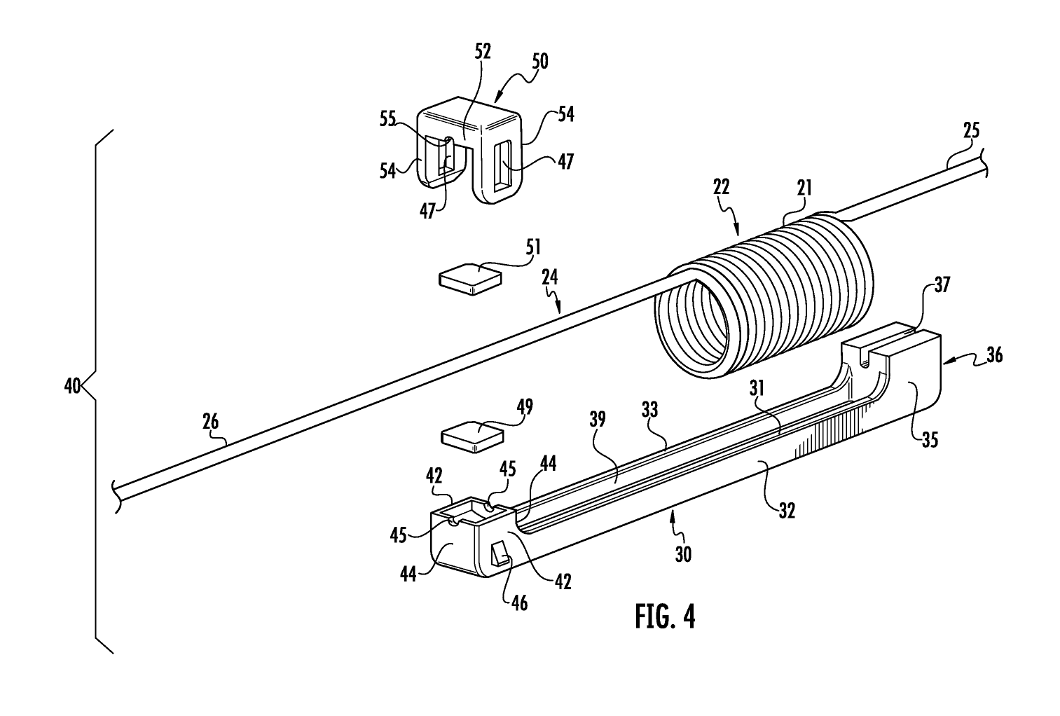

Extending coaxially through the center of the longitudinal axis L of spring 22 is the damping member 30, which is integrally molded of a polymeric material, such as ABS, polyethylene, polypropylene, or other suitable polymeric material. The damping member 30 includes a longitudinally extending leg 32 which extends coaxially through the spring 22 and has a first end 34 which terminates in a fixing member 36. Fixing member 36 is integral with the end 34 of leg 32 and secures the first extending end 25 of control rod 24 in longitudinally spaced relationship to attachment member 27. The leg 32 of damper member 30 is a generally U-shaped member, as best seen in FIG. 4, with a pair of spaced-apart legs 31 and 33, defining a channel 39 along its length. The end of leg 32 opposite fixing member 36 is a second end 38, which terminates in an integrally molded container 40 in spaced relationship between attachment 28 of spring 22 and body 21 of spring 22. Container 40 includes damping elements 49 and 51, as described below, which engage the control rod 24 and provide damping of the movement of control rod 24 through damper 20.

The fixing member 36 comprises a generally rectangular block 35 having a longitudinally extending slot 37 which fixedly grips the first end 25 of spring 22 to secure the end 25 of spring 22 to the damping member 30. The slot 37 is configured to tightly grip the end 25 of the control rod 24 against longitudinal movement and is dimensioned with respect to the diameter of the extending end 25 of spring 22 to do so. In some embodiments, a suitable bonding adhesive may be used to assist in anchoring end 25 to fixing member 36.

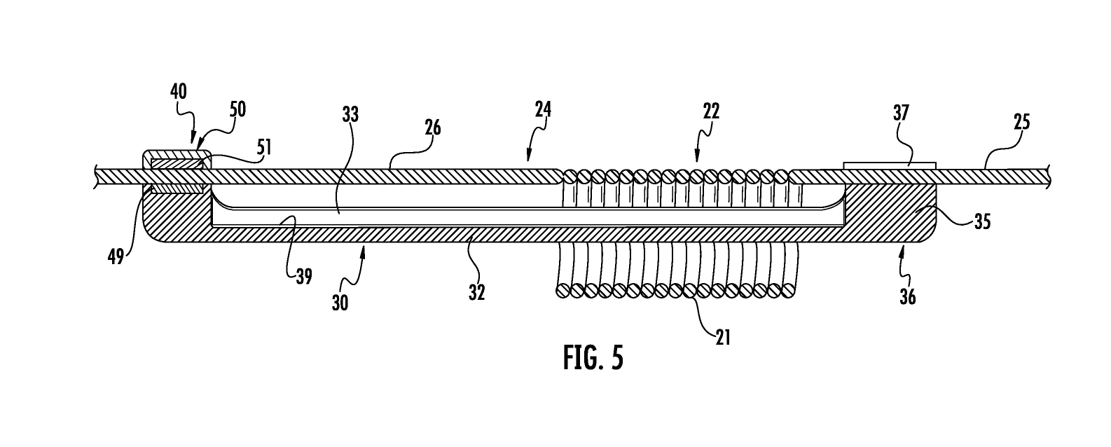

Container 40 and the damper elements 49 and 51 are best seen in FIGS. 4 and 5. The container 40 includes a box-like structure formed at the second end of leg 32 and, as seen in FIG. 4 (when opened), has a square container having side walls 42 and end walls 44 with semi-circular recesses 45 for guidably receiving control rod 24. The container 40 half shown in FIG. 4 is integral with the leg 32 of damper member 30 and includes a damping element 49 held in the shallow box-like half of container 40, as seen in FIG. 4. This section of the container includes a pair of outwardly projecting locking tabs 46 which, as seen in FIG. 2, interlock with slots 47 formed in cover 50 to snap-lock the cover 50 to container 40. The cover 50 is also generally square with a recess for receiving a second damping element 51 which engages the side of the control rod 24 opposite damping element 49 when cover 50 is snap-fit over tabs 46.

The cover 50 of container 40 likewise includes semi-circular recesses 55 (FIG. 4) for loosely receiving control rod 24 within the container 40 of damping member 20. Cover 50 is a generally U-shaped member, as seen in FIG. 4, having a base 52 and a pair of spaced-apart legs 54 in which slots 47 are formed. The slots 47 and tabs 46 are dimensioned such that the cover 50 snap-fits over the tabs 46 in tight compressive relationship, such that damping elements 49 and 51 grip the control rod 24 with sufficient force to provide the desired damping action provided by damping member 20. Each of the damping elements 49 and 51 are made of a foam material, such as a commercially available closed-cell foam polymeric material, such as polyurethane. The pad-like damping elements are coated with a lubricant, such as a commercially available highly temperature-stable lubricant, to provide the desired damping action once the container 40 is assembled with cover 50.

The pads 49 and 51 have a selected thickness to provide the desired compression between the damping elements and the control rod 24 to provide the desired damping action. In one embodiment, the pads were about 12 mm×12 mm×4 mm. The thickness and surface area of the damper elements, as well as the container 40, can vary as desired for a particular embodiment. In one embodiment, the width of leg 32 of the damping member was about 1.4 cm, with the legs having a height of about 0.71 cm. The overall length of one embodiment of the damper member 30 was about 16.5 cm. The length of the integral spring and control rod 24 was about 34.5 cm. These dimensions are representative of one embodiment of the invention but can be varied depending upon the application for a damper of this configuration.

FIG. 6 is a perspective view of an alternative embodiment of a damper 120 in which the same components as in the previously described embodiment are employed and are identified by the same reference numbers proceeded by a “1”. The container 140 is of the same construction of container 40 in the earlier embodiment, however, the fixing member 136 and spring end 125 are modified. Fixing member 136 includes, in addition to the longitudinal slot 137 for receiving end 125 of the extending leg of spring 122, a transversely extending notch 139 which receives a coined projection 129 formed on the end 125 of control rod 124. The interface between the coined enlargement of the outer diameter of end 125 of spring 122 fits within the notch 139 to positively anchor the control rod 124 at end 125 to damper member 130. Damper member 130 and control rod 124, together with the friction elements within container 140, are otherwise identical to that described in the earlier embodiments.

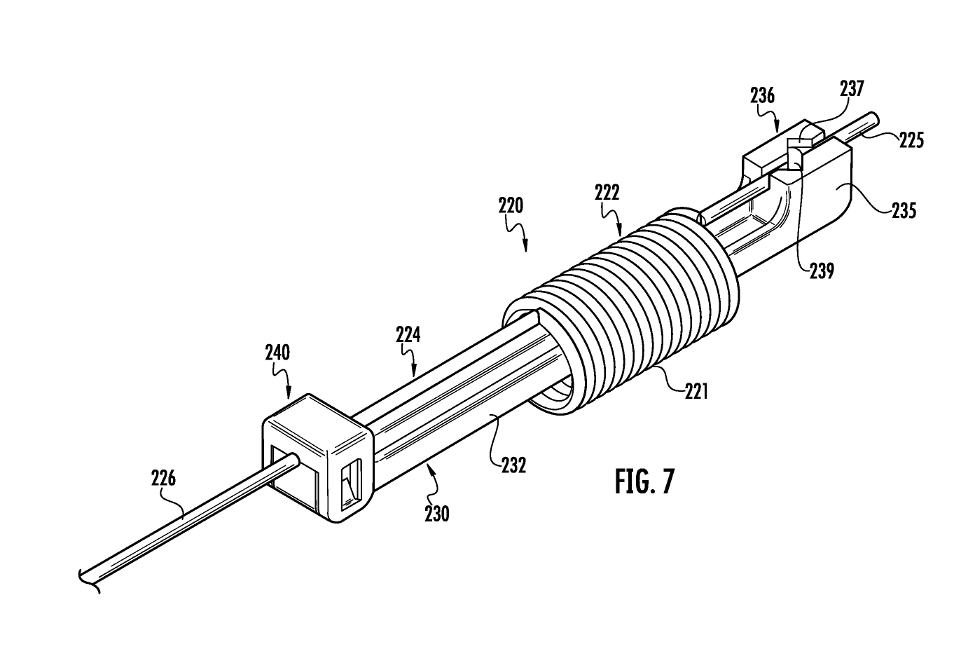

FIG. 7 shows an alternative embodiment of the damper identified as 220 in which common elements, as in previous embodiments, include the same last two digits. In this embodiment, the damper member 230 includes a longitudinally extending slot 237 in fixing member 236 which has a zig-zag pattern, as does the end 225 of the control rod 224, such that, when the zig-zag section 239 of end 225 of the control rod is fitted within the mating transversely offset zig-zag slot 237 of fixing member 236, the end 225 of control rod 224 is locked against longitudinal motion.

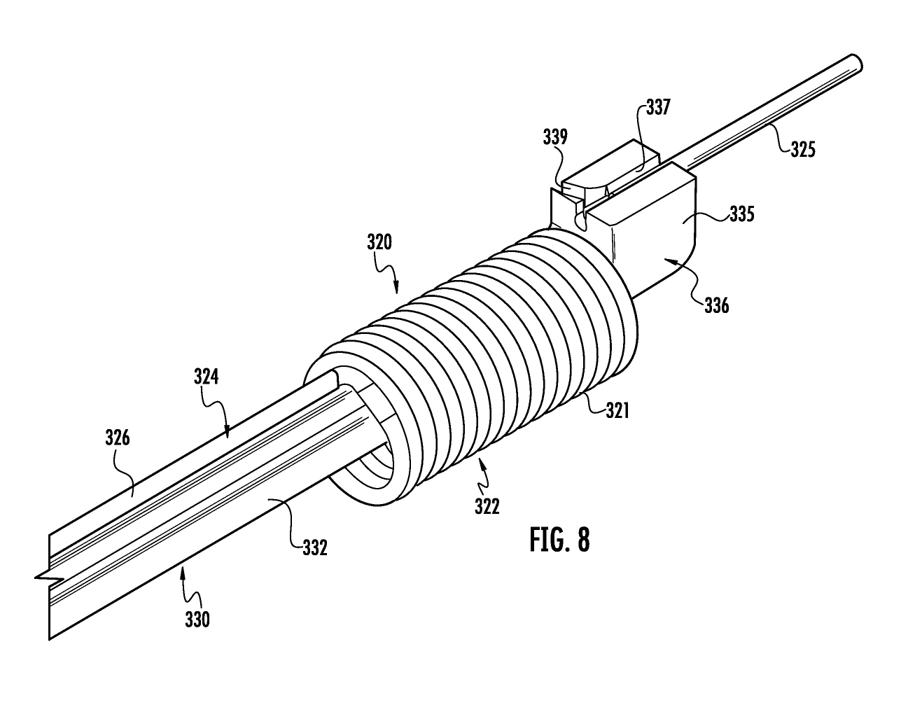

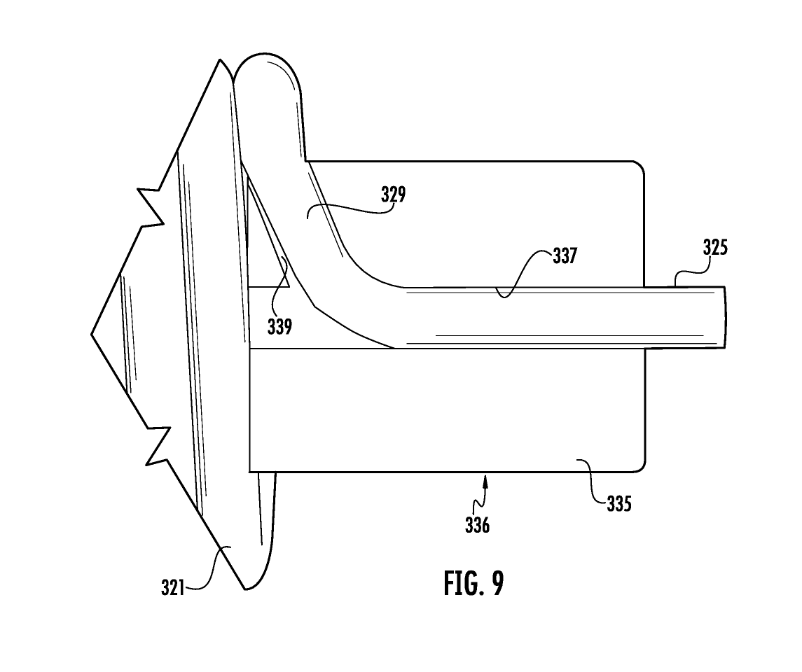

FIGS. 8-10 disclose yet another alternative embodiment of the damper identified as 320 with corresponding elements identified by the same last two digits as in the previous embodiments. In this embodiment, the extending end 325 of spring 322 of damper member 330 has a bend 329 (FIG. 9) which extends through a laterally extending slot 339 which communicates with slot 337 in fixing member 336. When the end 325 of the integrated spring and control rod 324 is positioned within the angularly inclined introduction slot 339 and longitudinally extending slot 337, the end 325 of control rod 324 is anchored in the fixing member 336. The remaining components of the damper 320, including the container at the opposite end of damper member 330, are identical to the previously described containers and damping elements and are not shown in FIGS. 8-10.

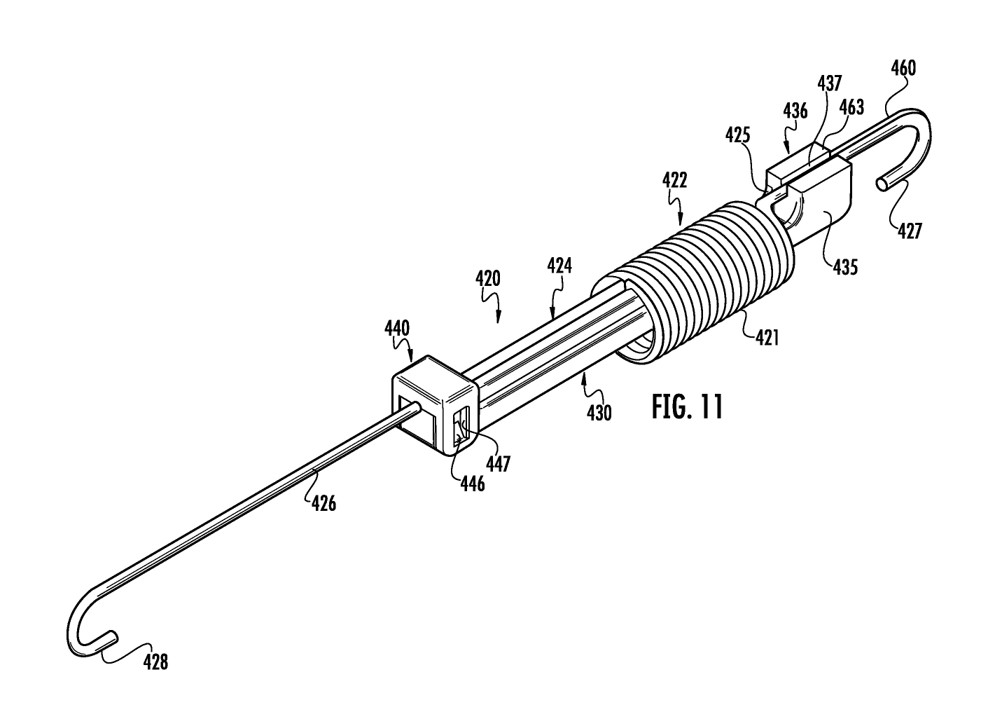

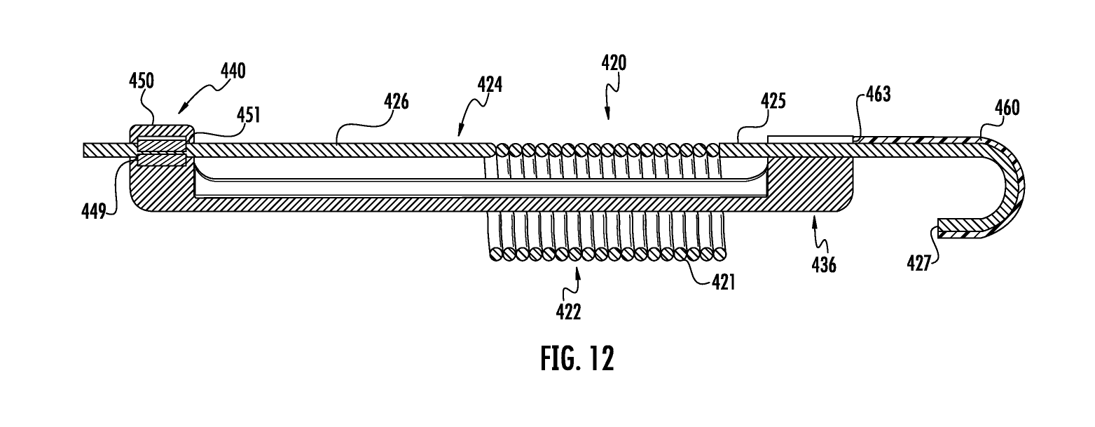

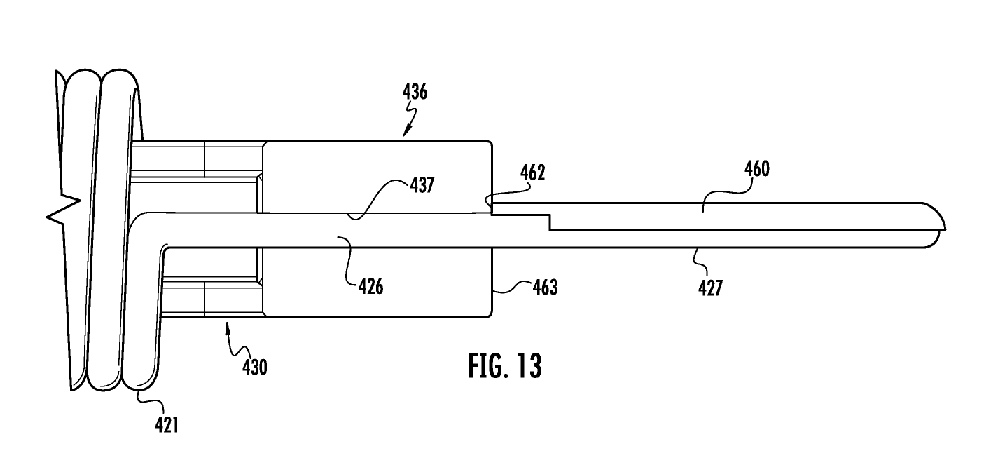

Another embodiment of the invention is shown in FIGS. 11-13 in which the same last two digits are used for structure corresponding to the previous embodiments. In FIGS. 11-13, a damper 420 is shown which includes a damper member 430 and an integrated spring with extending ends defining a control rod 424 integrally including spring 422 having a coil spring body 421 and extending ends 426 and 425. Extending end 426 terminates in an attachment hook 428, while end 425 terminates in an attachment hook 427. In this embodiment, the fixing member 436 includes a longitudinally extending slot 437, as in the first embodiment, however, the attachment hook 427 includes a polymeric cap 460 molded over hook 427 and which covers one half of the hook 427. As best seen in FIGS. 12 and 13, cap 460 has an end 462 which abuts the outer wall 463 of fixing member 436 to anchor the fixing member 436 against the attachment hook 427. As the spring 422 is expanded during operation of the damper 420, the fixing member 436 cannot move along extending end 425 but remains immediately adjacent the cap 460 of the attachment hook 427. The cap could be molded to encapsulate the entire end of the hook. There are a variety of matters in which the fixing member 36, 136, 236, 336, and 436 or the attachments can be anchored to the extending ends of the control rod defined by the integral spring with extending ends.

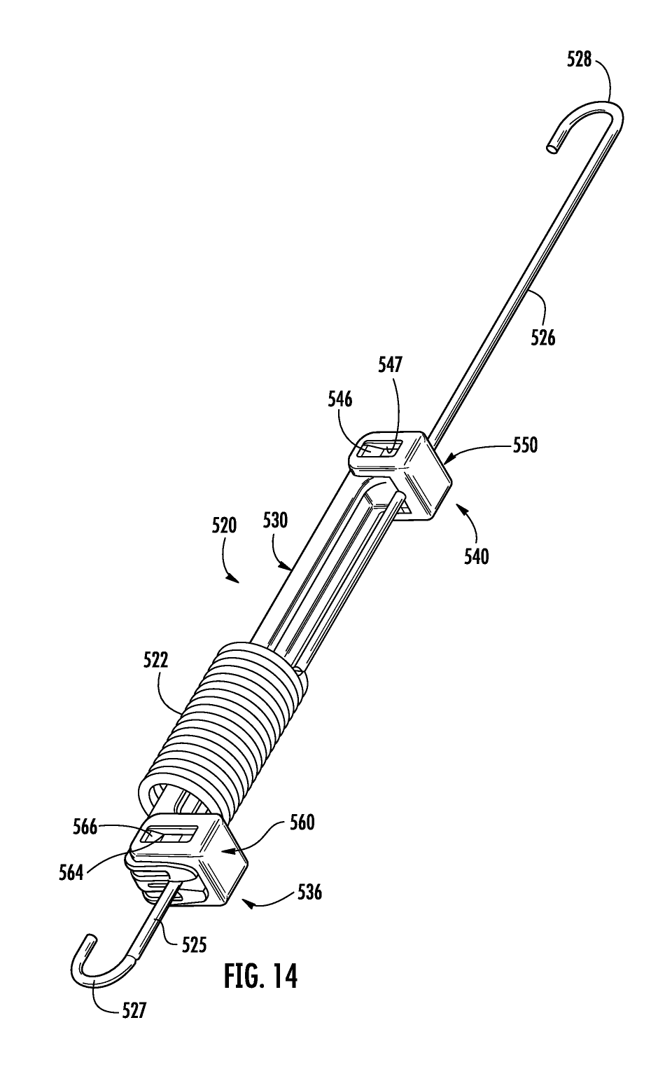

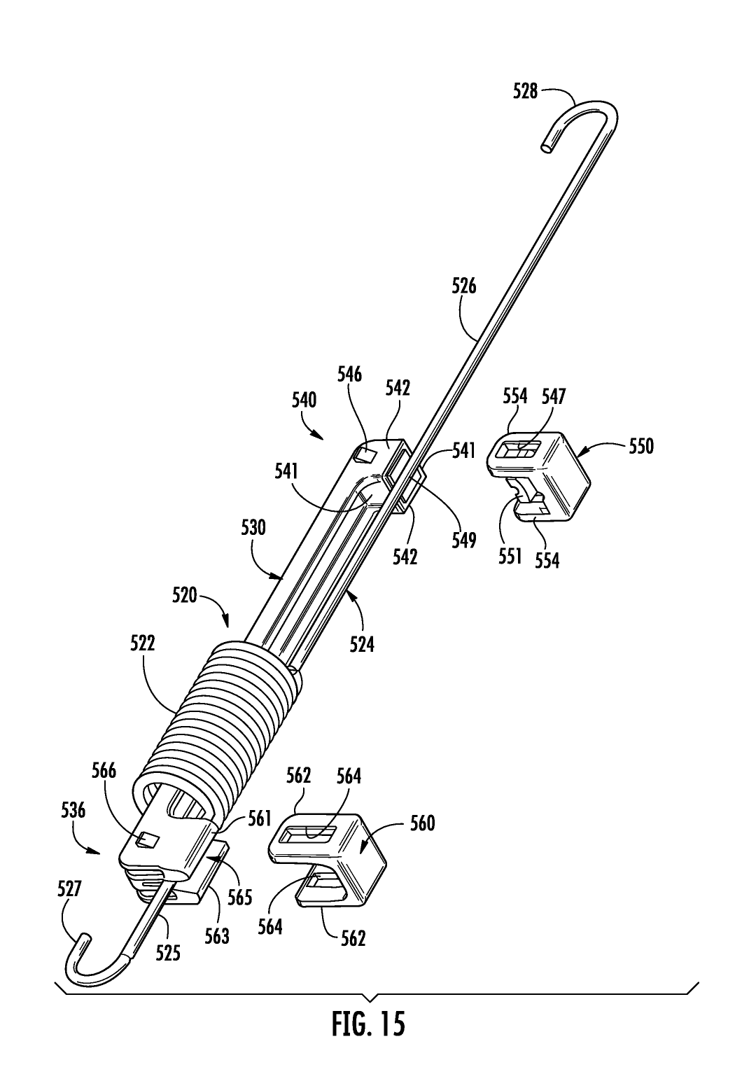

FIGS. 14 and 15 illustrate an alternative embodiment of a damper assembly 520 of the present invention in which a fixing member 536 and container 540 are similarly structured with a snap-on cover (560 and 550, respectively). In this embodiment, parts similar to the previous embodiments are identified with the same last two digits preceded by the numeral “5.” In FIGS. 14 and 15, the fixing member 536 comprises a pair of spread-apart legs 561 and 563 which define an inwardly tapered slot 565 between them. Extending end 525 from spring 522 of control rod 524 fits tightly within the tapered slot and, as best seen in FIG. 14, and is compressibly held by the cap 560, which has legs 562, each of which includes a slot 564 which fits over and a snap lock to tabs 566 on legs 561 and 563. Thus, when cap 560 is in place as seen in FIG. 14 on fixing member 536, it compresses the legs 561, 563 to firmly grip and hold extending end 525 from movement during operation of the damper.

The container 540 is constructed in the same member as the earlier described containers with damping element 549 on one side of extending end 526 of control rod 524 and a damping element 551 positioned within the cap 560. Cap 550 has spaced-apart legs 554 enclosing damping element 551. Each of the legs 554 includes notches 547 which snap-over locking tabs 546 in the legs 542 of container 540, which is generally box-shaped, enclosing end walls 541. Thus, in the embodiment shown in FIGS. 14 and 15, both ends of the damping member 530 include snap-on caps for the fixing member 536 and for the container 540 for the damping elements.

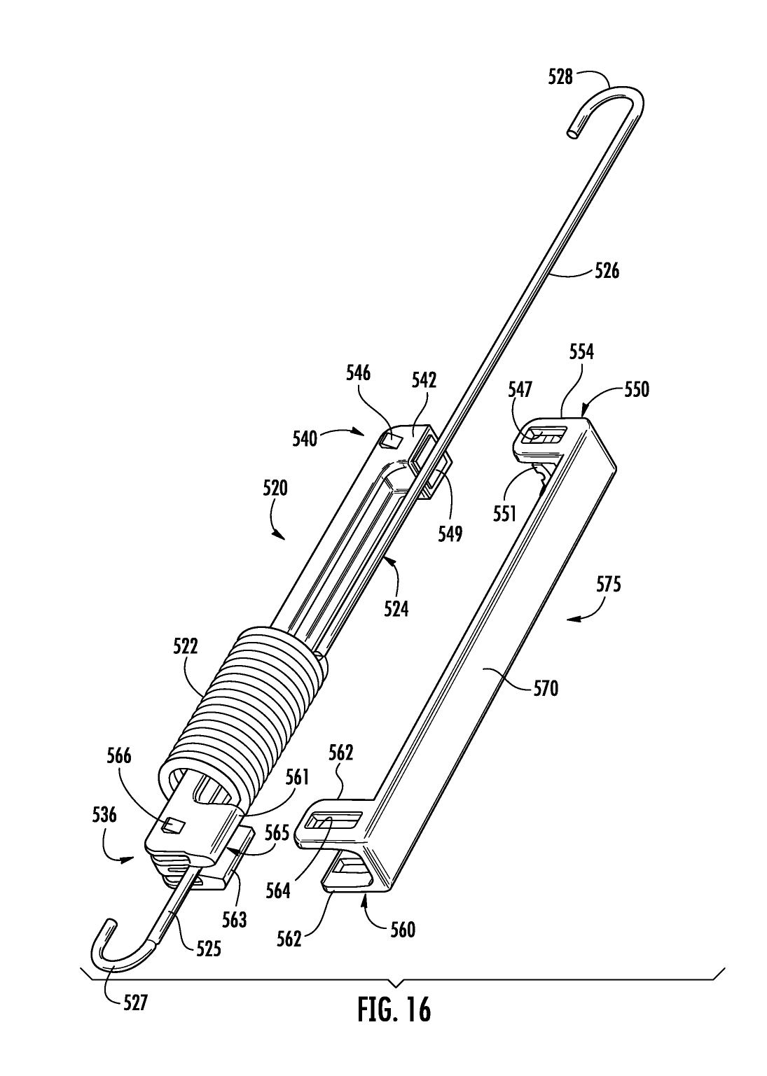

FIG. 16 shows yet another embodiment of the invention which has the same fixing member features and container for the damping elements as the FIGS. 14 and 15 embodiment. As a result, the corresponding elements have the same reference numbers. The caps 550 and 560 in the FIG. 16 embodiment are joined by an interconnecting bar 570 which is an integrally molded piece 575 that includes both the cap 550 and its associated structure and cap 560 and its associated structure, as in the embodiments of FIGS. 14 and 15. Bar 570 is spaced outside of the spring 522 and in parallel longitudinal alignment with axis of the spring but is spaced from the spring a distance sufficient so as not to interfere with the expansion and contraction of spring 522 during operation of the damper 520, shown in FIG. 16.

It will become apparent to those skilled in the art that various modifications to the preferred embodiment of the invention as described herein can be made without departing from the spirit or scope of the invention as defined by the appended claims.

1. An integral spring and rod for a damper comprising:
a coil spring having a longitudinal axis, said spring including first and second extending ends which extend longitudinally from said spring, wherein at least one of said ends defines a damper control rod; and
wherein each of said ends terminate in an attachment.

2. The integral spring and rod as defined in claim 1 wherein said attachments are integral with said first and second extending ends.

3. The integral spring and rod as defined in claim 2 wherein at least one of said attachments comprises a hook.

4. The integral spring and rod as defined in claim 2 wherein said attachments are hooks formed in each of said extending ends.

5. The integral spring and rod as defined in claim 3 wherein said second extending end is longer than said first extending end and is said damper control rod.

6. A friction rod damper comprising:
a coil spring having a longitudinal axis, said spring having a body and first and second extending ends which extend longitudinally from said spring, wherein at least one of said ends defines a damper control rod; and
a damper member coupled to said spring and having a first end secured by a fixing member to said first extending end of said spring, said damper member including a second end with a container surrounding said second extending end of said spring at a location spaced from said body of said spring, said container including a damping element engaging said second extending end of said spring, wherein said damper member allows said spring to expand and contract under the damping action of said damping element.

7. The damper as defined in claim 6 wherein said damping element comprises a pair of friction pads engaging opposite sides of said second extending end of said spring.

8. The damper as defined in claim 6 wherein said fixing member comprises a block at said first end of said damper member, said block having a longitudinally extending slot for fixedly receiving said first extending end of said spring.

9. The damper as defined in claim 6 wherein said fixing member comprises a block at said first end of said damper member, said block having a longitudinally extending slot and a transverse notch, and wherein said first extending end of said spring is coined at a location to align in said notch when said first end of said spring is inserted into said slot.

10. The damper as defined in claim 6 wherein said fixing member comprises a block at said first end of said damper member, said block having a longitudinally extending slot with a zig-zag offset section, and wherein said first extending end of said spring has a corresponding zig-zag section which fits within said block to lock said first end of said spring to said damper member.

11. The damper as defined in claim 6 wherein said fixing member comprises a block at said first end of said damper member, said block having a longitudinally extending slot and an angled slot communicating with said longitudinally extending slot, and wherein said first extending end of said spring is inserted into said angled slot and said longitudinally extending slot to lock said first end of said spring to said damper member.

12. The damper as defined in claim 6 wherein said fixing member comprises a block at said first end of said damper member, said block having a longitudinally extending slot for receiving said first extending end of said spring and wherein said second extending end of said spring includes a polymeric cover which prevents a terminal end of said second extending end of said spring from moving into said longitudinally extending slot.

13. The damper as defined in claim 6 wherein said damper member is integrally molded of a polymeric material.

14. The damper as defined in 6 wherein said damper comprises a leg with said fixing member at a first end of said leg and said container at a second end of said leg.

15. The damper as defined in claim 14 wherein said leg extends through said body of said coil spring.

16. A friction rod damper comprising:
a coil spring having a longitudinal axis, said spring having a body and first and second extending ends which extend longitudinally from said body of said spring to define a control rod for said damper, said ends terminating in attachments; and
a damper member extending through said spring and having a first end secured to said first extending end of said spring in spaced relationship to an associated attachment, said damper member including a second end with a container surrounding said second extending end of said spring at a location between said body of said spring and an associated attachment, said container including a damping element engaging said second extending end of said spring, wherein said damper member allows said spring to expand and contract against the damping action of said damping element.

17. The friction rod damper as defined in claim 16 wherein said damper member includes a longitudinally extending leg coaxially extending through said spring and wherein said first end of said damper member is anchored to said first extending end of said spring in spaced relationship to said attachment.

18. The friction rod damper as defined in claim 17 wherein said container is positioned intermediate said body of said spring and said attachment at said second extending end of said spring.

19. An integral spring and rod for a damper comprising:
a coil spring having a longitudinal axis, said spring including at least one extending end which extends longitudinally from said spring, wherein said at least one end defines a damper control rod; and
wherein said at least one end is terminated in an attachment.

20. The integral spring and rod as defined in claim 19 wherein said attachment is integral with said extending end.

21. The integral spring and rod as defined in claim 20 wherein said attachment comprises a hook.

22. A friction rod damper comprising:
a coil spring having a longitudinal axis, said spring having a body and first and second extending ends which extend longitudinally from said spring, wherein at least one of said ends defines a damper control rod; and
a damper member coupled to said spring and having a first end secured by a fixing member to said first extending end of said spring, said damper member including a second end with a container surrounding said second extending end of said spring at a location spaced from said body of said spring, said container including a damping element engaging said second extending end of said spring, wherein said damper member allows said spring to expand and contract under the damping action of said damping element, wherein said fixing member comprises a block at said first end of said damper member with a tapered slot and a snap-on cap for fixedly securing said first extending end of said spring to said damper member, and wherein said container comprises a two-piece open box and snap-on cap.

23. The damper as defined in claim 22 wherein said damper comprises a leg with said fixing member at a first end of said leg and said container at a second end of said leg, said leg extending through said body of said coil spring.

24. The damper as defined in claim 23 and further including a second leg coupling snap-on caps, said second leg extending outside of said spring in parallel-spaced relationship to the longitudinal axis of said spring.
